(19) United States
(12) Patent Application Publication
(10) Pub. No.: US 2024/0273166 A1
(43) Pub. Date: Aug. 15, 2024

(54) SYSTEM AND METHOD RELATING TO MONITORING OF LICENSING ACTIVITY

(71) Applicant: Rakuten Symphony India Private Limited, Indore, MP (IN)

(72) Inventors: Sameer PANCHOLI, Indore (IN); Shubhangi GADHAVE, Indore (IN)

(21) Appl. No.: 18/007,483

(22) PCT Filed: Nov. 17, 2022
(86) PCT No.: PCT/US2022/050285

§ 371 Date: Jan. 31, 2023

(51) Int. Cl. G06F 21/10

(52) U.S. Cl. CPC G06F 21/105

(57) ABSTRACT

A system and method of automating and monitoring a license application in a license application module for a telecommunication network. The method including triggering, in response to completion of construction of a base station in the telecommunication network, generation of a license application in the license application module. The method including reviewing of the license application in the license application module to determine compliance with a criterion of a third-party. The method including exporting of the license application from a database in the license application module in a format compatible to be received at an external database by the third-party. The method including receiving, by the carrier, of the license application from the third-party. The method including triggering, in response to an approval of the license application by the third-party, activation of the base station such that a subscriber of the carrier is able to access the telecommunication network.

### TECHNICAL FIELD

This description relates to a system relating to monitoring of a licensing activity and method of using the same.

### BACKGROUND

A telecommunication network is a complex system, and utilizes an extensive amount of equipment to successfully operate, and provide access to users of the network. Base stations, in numerous forms, represent said equipment. A base station provides a radiating signal which allows a customer or subscriber of the telecommunication network to access a signal transmitted by a base station from a user device, such as a mobile phone, tablet, computer, or similar device. A carrier or network provider provides a network, and subscribers subscribe to a network. A significant amount of logistics and planning goes into deciding where a base station within a coverage area of a telecommunication network should be constructed or installed so as to provide adequate coverage for a subscriber within a particular geographic area.

With increasing demand for high speed data coverage, there is in turn an increasing number of base stations and other network equipment used to satisfy the demand. And with an increasing demand, there has also been increasing regulation for network providers to obtain a license for a base station or other network equipment before making a base station operable and available to subscribers. There are numerous contractors and stakeholders involved in the process of planning and constructing a base station or other network equipment available to subscribers, and from start to finish, for example, surveying a geographical area, to construction, and lastly turning a base station or other network equipment on/activation.

### SUMMARY

In at least one embodiment, a method of generating a license application includes obtaining license information from a database, presenting, on a display device, a plurality of license data forms in respective workflows of a license application module, and each license data form is compiled to generate a license application using a graphical user interface (GUI) for determining a base station's or other network equipment's compliance with a third-party, presenting, on a display device, a workflow GUI for selecting generation of a license application including data associated with a new base station or other network equipment, based on information obtained from survey data discussed further below, generating a license application according to survey data and other types of data which are automatically fetched or collected, and which populate a workflow GUI, and displaying a license application on a display device, and to bring a new base station or other network equipment “on air”.

At least one embodiment includes a memory storing computer-readable instructions, and a processor connected to the memory, wherein the processor is configured to execute the computer-readable instructions to obtain survey data from a database, present, on a display device, a license application module graphical user interface (GUI) for generating a new license application to obtain a license from a third-party granting the license, present, on the display device, a license application module GUI for selecting generation of a license application including data associated with a new base station or other network equipment constructed or installed, based on the survey data, generate the report according to the selecting made using the license application module GUI and displaying the license application on the display device, receive input in the license application module GUI, and submitting the license application to the third-party to obtain a license so as to activate a new base station or other network equipment, i.e., to bring the new base station “on-air”.

In at least one embodiment, a non-transitory computer-readable media having computer-readable instructions stored thereon, which when executed by a processor causes the processor to obtain survey data from a database, presenting, on a display device, a license application graphical user interface (GUI) for inputting information related to a new base station or other network equipment, presenting, on the display device, a license application module GUI for selecting a workflow and inputting data associated with the new base station or other network equipment, based on the survey data, generating the license application according to the selecting made using the license application module GUI, and displaying the license application on the display device, and exporting the license application to a third-party.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flow chart of data sources fetched for generation of a license application, and a review process leading up to submission to a third-party for validation of the license application according to at least one embodiment.

FIG. 2 is a graphical user interface (GUI) of a landing page in a license application module according to at least one embodiment.

FIG. 3 is a GUI of a page within a workflow of the license application module having parameters and corresponding fillable data fields relating to acceptance testing according to at least one embodiment.

FIG. 4 is a GUI of a page within a workflow of the license application module having information particular to a third-party according to at least one embodiment.

FIG. 5 is a GUI having parameters and corresponding fillable data fields relating to a third-party's specifications for a license application according to at least one embodiment.

FIG. 6 is a GUI having parameters and corresponding fillable data fields relating to location information for a license application able to be entered according to at least one embodiment

FIG. 7 is a GUI of a data file having information compiled from the aforementioned pages within a workflow of a license application module, and exportable to a third-party's database according to at least one embodiment.

FIG. 8 is a high-level functional block diagram of a processor-based system according to at least one embodiment.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

There is opportunity for human error due to miscommunication and delay between the numerous contractors and stakeholders involved in the various processes of planning and constructing a base station or other network equipment, or data being repeatedly entered manually and incorrectly. One of these processes where said problems recur relates to licensing and other agreements, which are typically obtained from a third-party, such as a government entity like the Ministry of Internal Affairs and Communications in Japan (“MIC”).

Automating and monitoring of the licensing process, such that a carrier or network provider is able to provide access to a base station or other network equipment to users in the carrier's network after a license is executed or in place, after construction or installation, or other preceding steps addresses these recurring problems, to be discussed in the below embodiments. Hence, automating and monitoring of the interactions between the different stakeholders and processes contingent and interfacing with each other would expedite the licensing process leading to activation of a base station or other network equipment newly added to a telecommunication network.

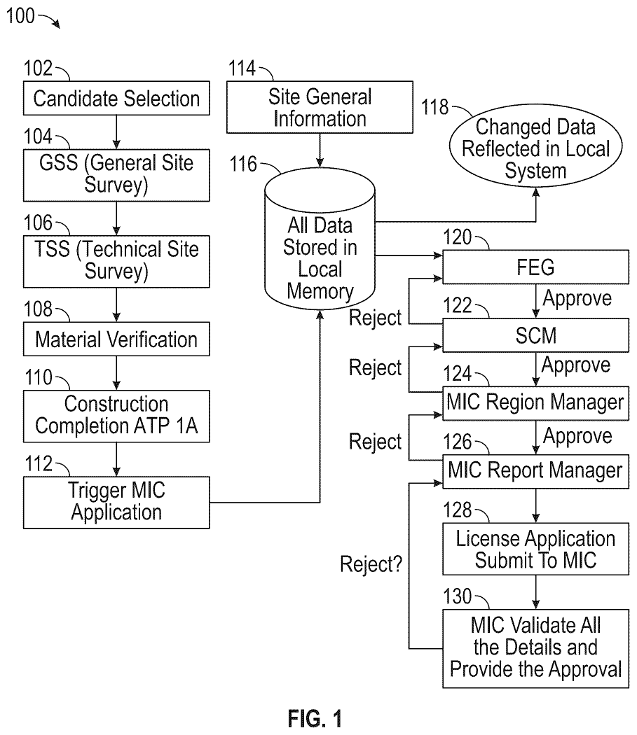

FIG. 1 is a flow chart 100 of the data sources fetched for a license data form in a workflow of a license application module, reviewing of a license data form, and generating a license application, and exporting a license application to a third-party for validation of a license application, and receiving an approval or rejection of a license application from a third-party according to at least one embodiment.

Method 100 includes operation 102 for candidate selection, in which candidate selection refers to determining or selecting of a location or target site of where to construct or install a base station or other network equipment. In some embodiments, a candidate as to where a location or target site will be is finalized out of a plurality of candidates. In some embodiments, a carrier or network provider assigns an engineer to visit a location or target site. In some embodiments, an engineer is an employee of a carrier or network provider. In some embodiments, an engineer is an employee of a contractor. In some embodiments, a result of the determination of the selected candidate is transmitted to a system that is able to implement method 100.

In some embodiments, a selected location includes a plurality of target sites which are determined as candidates for construction or installation of a base station or other network equipment. In some embodiments, some of the plurality of target sites within a selected location are determined as candidates for construction or installation while other target sites in the same area are still undergoing evaluation. In some embodiments, a determination regarding candidate selection is stored in a cloud based storage architecture or in a local storage medium. In some embodiments, a local storage medium is at a data center which is managed by personnel on-site or managed remotely.

Method 100 includes operation 104 for a general site survey (“GSS”), in which a GSS refers to determining how many users would be able to receive coverage from a base station or other network equipment constructed or installed at a target site. In some embodiments, a GSS is performed by a field engineer, and the field engineer visits the target site. In some embodiments, information relating to ground space, equipment, facilities, utilities, assessments of tower equipment and antenna types, as well as further review of candidate selection(s), locations surrounding candidate selection(s) and ownership status of real property, as well as compliance reviews, are obtained. In some embodiments, information obtained during a GSS is transmitted to a system which is able to implement method 100. In some embodiments, information obtained during a GSS is stored in a cloud based storage architecture or in a local storage medium. In some embodiments, a local storage medium is at a data center which is managed by personnel on-site or managed remotely.

Method 100 includes operation 106 for a technical site survey (“TSS”), in which a TSS refers to determining a quantity of sectors to be constructed or installed at a target site, for example, a three-sector site, six-sector site, or other. A three-sector site has three arrays or antenna devices and one radio interface unit(s) (“RIU”) device. A six-sector site has six arrays or antenna devices and two RIU devices. A TSS is performed by a field engineer. A field engineer visits a target site, plans and designs a network, and verifies a plurality of technical parameters. A field engineer also captures photos and other details for a target site, also stored in a cloud based storage architecture or in local storage medium. In some embodiments, information relating to cabling, network components (routers, switches, servers, and similar), wi-fi coverage, data rates, network capacity, roaming capability, are obtained. In some embodiments, information obtained during a TSS is transmitted to a system which is able to implement method 100. In some embodiments, information obtained during a TSS is stored in a cloud based storage architecture or in a local storage medium. In some embodiments, a local storage medium is at a data center which is managed by personnel on-site or managed remotely.

Method 100 includes operation 108 for material verification, in which material verification refers to inventorying all materials and components (e.g., the three arrays or antenna devices and the one RIU device) determined to be necessary, during a GSS and a TSS, for construction of a base station or other network equipment to commence at a target site. In some embodiments, information obtained during inventorying is transmitted to a system which is able to implement method 100. In some embodiments, information obtained during inventorying is stored in a cloud based storage architecture or in a local storage medium. In some embodiments, a local storage medium is at a data center which is managed by personnel on-site or managed remotely.

Method 100 includes operation 110 for construction completion, also known as acceptance testing, wherein construction completion refers to successful testing likely to be in compliance with a third-party granting a license. In some embodiments, radio frequency (“RF”) cable testing is performed to determine modulation quality, for example, of LTE base stations. In some embodiments, testing measures occupied bandwidths, channel power, error vector magnitude, loss of efficiency due to distortion from cable and antenna feed reflections, as well as a variety of other metrics related to modulation quality. In some embodiments, information obtained during acceptance testing is transmitted to a system which is able to implement method 100. In some embodiments, information obtained during acceptance testing is stored in a cloud based storage architecture or in a local storage medium. In some embodiments, a local storage medium is at a data center which is managed by personnel on-site or managed remotely.

Method 100 includes operation 112 for creating a license data form in a workflow in a license application module, in which a workflow is automatically triggered or generated based on acceptance testing of a base station or other network equipment after construction is completed. Initially, in other words before acceptance testing is completed a license application has a “pre-application” status. After acceptance testing is completed a license data form in a workflow in a license application module is stored in a cloud based storage architecture or local storage medium, and a workflow is accessible to a user, such as a field engineer, a sub-contractor manager (e.g., an internal manager of a carrier or network provider who manages and monitors a sub-contractor doing construction or installation), a regional manager, or a report manager, all of whom are able to acquire or select a workflow for a particular license application and assign a task to themselves associated with a particular license application, or assign a task to another associated with a particular license application.

In some embodiments, a large number of base stations or other network equipment have undergone acceptance testing and trigger a plurality of license data forms in workflows of a license application module corresponding to a plurality of license applications to be prepared in bulk. By having a plurality of license applications prepared in bulk simultaneously promotes efficiency of expanding to provide enhanced coverage of a carrier or network provider's network, and customer satisfaction is increased as a result, as well.

In some embodiments, a user is notified of a license data form in a workflow of a license application module by text message, email, alarm, or other notification.

Method 100 includes operation 114 for general information about a target site, in which general information about a base station or other network equipment at target site is collected from operations 102, 104, 106, 108, and 110, and are stored in a cloud based storage architecture, and downloadable and storable in a local storage medium 116, as discussed below.

Method 100 includes operation 116 for storing data collected from operations 102, 104, 106, 108, and 110, as well as a license application module, in which information about a base station or other network equipment is stored in a local storage medium, and is fetched and populated in a license data form in a workflow of the license application module.

Method 100 includes operation 118 for changing/updating data, in which any changes or updates in data about a base station or other network equipment are stored locally. In some embodiments, a changes or updates are able to be stored locally on a separate storage medium or on the local storage medium of feature 116. In some embodiments, changes or updates are automatically performed. In some embodiments, changes or updates are able to be manually performed.

Method 100 includes operation 120 for a field engineer's (“FEG”) review of data for a base station or other network equipment in a license data form. A FEG receives a license data form in a workflow of a license application module having the data obtained in operation 116, and the data populating fillable data fields about a base station or other network equipment. A FEG reviews a license data form in a workflow of a license application module and approves or rejects a license data form based on whether data is accurate. In some embodiments, a FEG is the same user who collected the data during the candidate selection 102, the general site survey (“GSS”) 104, or the technical site survey (“TSS”) 106. In some embodiments, a FEG is able to verify the data inputted into a workflow manually. In some embodiments, a FEG is able to verify the data inputted into a workflow automatically.

Method 100 includes operation 122 for a sub-contractor manager's (“SCM”) review of data in a license data form of a license application module. Upon a FEG's verification, a SCM receives a license data form in a workflow of a license application module with the data populated in the fillable data fields, and any updates based on a FEG's verification. A SCM reviews a license data form in a workflow of a license application module and approves or rejects the license data form based on whether the data is accurate. In some embodiments, a SCM will contact a contractor whom the SCM is the responsible manager for, and confer with the contractor to make any corrections, if necessary, to the data in the license data form. In some embodiments, the SCM will contact a plurality of contractors, if necessary. In some embodiments, a contractor is able to have limited access to the license application module to make any corrections to the data in the license data form. In some embodiments, the SCM will receive a notification through the license application module informing the SCM that a contractor has made corrections to the data in the license data form. In some embodiments, the SCM is able to verify the data inputted into the workflow manually. In some embodiments, the SCM is able to verify the data inputted into the workflow automatically. In a scenario where the SCM approves the license data form, a notification is sent via the license application module to the regional manager informing the regional manager that the license data form is ready for review. Alternatively, in a scenario where the SCM rejects the license data form, a notification is sent via the license application module to the FEG to be revised. In some embodiments, the notification is automatically sent informing the user that the license data form is ready for review or revision. In some embodiments, the notification is manually sent by a user informing another user that the license data form is ready for review or revision.

Method 100 includes operation 124 for a regional manager's review of data in a license data form of a license application module. Upon a SCM's approval, a regional manager receives a license data form in a workflow of a license application module, and approves or rejects the license data form based on whether the data is accurate. The regional manager is able to input license data specific to a third-party's specifications or requirements, i.e., data in addition to the technical data entered by a FEG—the technical data being entered into the license data form in a workflow of the license application module before the workflow is received by a SCM, and then the regional manager. For example, the license application will be submitted to the Ministry of Internal Affairs and Communication, hence the regional manager (and the report manager) has familiarity and expertise with the specifications or requirements of this particular third-party. In some embodiments, an assistant to the regional manager is able to input data into the license data form based on data provided by and under the direction of the regional manager. In some embodiments, the regional manager is able to verify the data inputted into the workflow manually. In some embodiments, the regional manager is able to verify the data inputted into the workflow automatically. In a scenario where the regional manager approves the license data form, a notification is sent via the license application module to the report manager informing the report manager that the license data form is ready for review. Alternatively, in a scenario where the regional manager rejects the license data form, a notification is sent via the license application module to the SCM to be revised. In some embodiments, a notification is sent via the license application to the FEG to be revised. In some embodiments, the notification is automatically sent informing the user that the license data form is ready for review or revision. In some embodiments, the notification is manually sent by a user informing another user that the license data form is ready for review or revision.

Method 100 includes operation 126 for a report manager's review of data in a license data form of a license application module. Upon a regional manager's approval, a report manager is also able to input license data specific to a third-party's specifications or requirements, i.e., data in addition to the technical data entered by a FEG, SCM, or a contractor. For example, the license application will be submitted to the Ministry of Internal Affairs and Communication, hence the report manager has familiarity and expertise with the specifications or requirements of this particular third-party. In some embodiments, an assistant to the report manager is able to input the license data based on data provided by and under the direction of the report manager. The report manager verifies the data inputted into the license data form in the workflow. In some embodiments, the report manager is able to verify the data inputted into the workflow manually. In some embodiments, the report manager is able to verify the data inputted into the workflow automatically. In a scenario where the report manager approves the license data form, a notification is sent via the license application module to the other users/reviewers that license application is being submitted to the third-party. Alternatively, in a scenario where the report manager rejects the license data form, a notification is sent via the license application module to the regional manager to be revised. In some embodiments, a notification is sent via the license application module to the SCM to be revised. In some embodiments, a notification is sent via the license application module to the FEG to be revised. In some embodiments, the notification is automatically sent informing the user that the license data form is ready for review or revision. In some embodiments, the notification is manually sent by a user informing another user that the license data form is ready for review or revision.

In operation 128, upon the report manager's approval the data in the license data form is extracted to generate a license application with the populated information about the base station or other network equipment. The license application is able to be exported to the third-party for external review. In some embodiments the license application is submitted to an external device, such as a server of a third-party. In some embodiments the license application is transmitted via an internet network to the server of the third-party. In some embodiments, the license application is transmitted wirelessly to the server of the third-party. In some embodiments, the license application is transmitted via wired connection.

In operation 130, the third-party is able to receive the license application to review and validate the information presented therein. After the third party reviews and validates the information in the license application, the third-party then sends the license application back to the carrier or the network provider. In response to the third-party approving/positive response to the license application, the base station or other network equipment is able to be activated, thus made available in the telecommunication network to subscribers. In some embodiments, the base station or other network equipment is able to be activated automatically. In some embodiments, the base station or other network equipment is able to be activated manually. In response to the third-party rejecting/negative response the license application then the license application is subject to further review.

In the latter scenario where the license application is rejected, a negative response is received from the external device, such as a server of a third-party. The negative response includes a feedback report on the license application submitted in operation 128. In some embodiments where a plurality of license applications is rejected, a negative response including a feedback report is provided for each license application. In response to the license application being rejected, the method 100 first proceeds back to operation 126 to the report manager. In operation 126, the report manager updates the license application to address concerns raised by the negative response received in operation 130. In some embodiments, a rejection/negative response indicates an uncompleted application, such as, but not limited to, information missing from a license application. In operation 126, the report manager is able to identify from where in the license application is the information missing. In some embodiments, a report manager determines that the report manager is not responsible for the missing information, and a notification, such as an email or text message, is created in the license application module and sent to a responsible user. In some embodiments, a regional manager is determined to be responsible for the missing information, and a notification is sent to the region manager in operation 124. In some embodiments, a SCM is determined to be responsible for the missing information, and a notification is sent to the SCM in operation 122. In some embodiments, a FEG is determined to be responsible for the missing information, and a notification is sent to the FEG in operation 120. Upon receiving the notification that a license application is rejected, the responsible manager/user reviews the feedback report and revises the license application accordingly.

In some embodiments, a system that is able to implement method 100 recommends information to address the concerns of a negative response or automatically generates a request for additional information sought by the negative response. In some embodiments, the recommendation information is based on previous applications which experienced a rejection at a similar stage as the previous application proceeded through method 100. In response to a license application being updated in operations 126, 124, 122, or 120, method 100 proceeds to operation 128 in which the updated application is transmitted to the third-party again for review and approval.

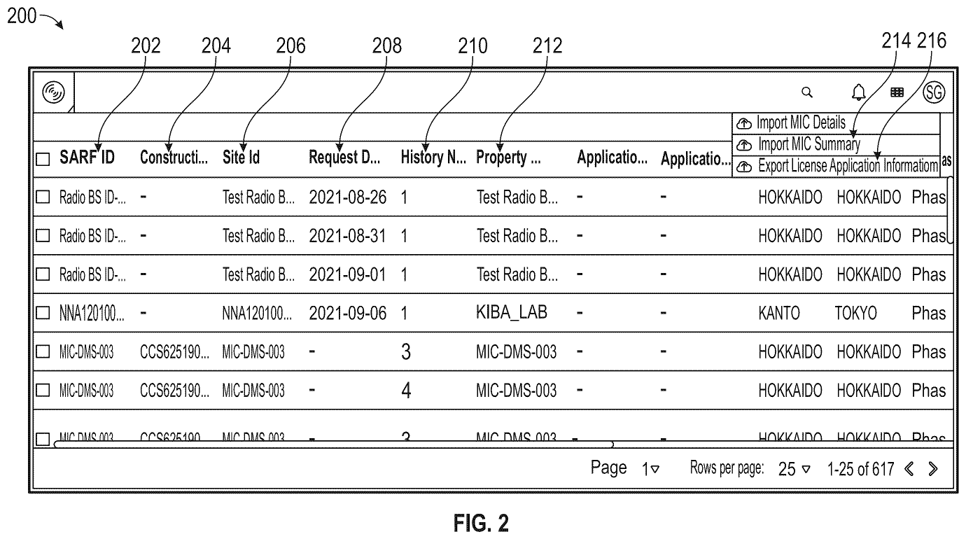

FIG. 2 is a graphical user interface (“GUI”) 200 of a license application workflow for managing a license application, the workflow having a landing page with rows and columns of fields of data, each row relating to a workflow or task corresponding to a respective license application.

GUI 200 includes feature 202 for a Site Acquisition Request Form (“SARF”), which refers to an identifier for the site at which a base station or other network equipment is constructed or installed.

GUI 200 includes feature 204 for a Construction ID, which refers to an identifier for the construction at a target site. The received data includes a construction ID corresponding to a target site in the license application. In some embodiments, the received data includes multiple construction IDs for multiple target sites for which license applications are being sought.

GUI 200 includes feature 206 for a Site ID, which refers to an identifier for the geographic location of the site.

GUI 200 includes feature 208 for a Request Date, which refers to the date a license application was exported to the third-party for review by the third-party of the license application to request a license.

GUI 200 includes feature 210 for a History Number(s), which refers to the number of resubmissions to the third-party granting approval of a license after reviewing the license application. For example, in this GUI, in the first four rows only one request was made of the third-party for review of a license application, and the license application was approved. In row 5, there is a history of three requests, hence the license application was rejected three times. In row 6, there is a history of four requests, hence the license application was rejected four times.

GUI 200 includes feature 212 for a Property, which refers to the owner of the land on which the base station or other network equipment is constructed or installed upon. In some embodiments, the carrier or network provider is the owner of the land or structure upon which a tower to which the base station may be connected to, is located, also known as passive infrastructure. In some embodiments, the third-party granting the license application is the owner of the property, or some other party.

GUI 200 includes graphical icon 214 to “Import Third-party Details”, by which a user is able to select a graphical icon to import details, not automatically generated upon completion of construction of the base station or other network equipment, from a cloud based storage architecture, as well as summary information.

GUI 200 includes graphical icon 216 to “Export License Application Information”, by which a user is able to select a graphical icon to export the license application from a cloud based storage architecture to a third-party.

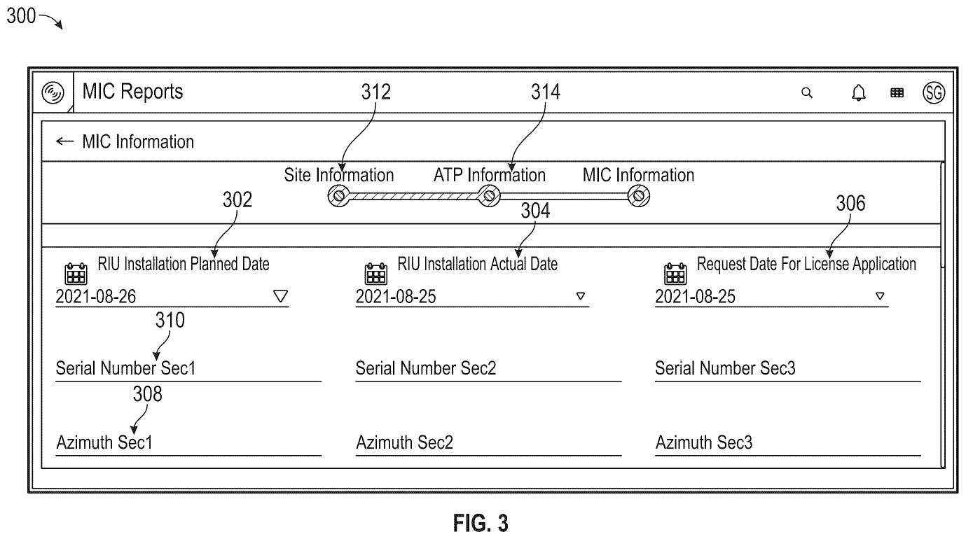

FIG. 3 is a GUI 300 having parameters and fillable data fields where acceptance testing information (after construction completion) is able to be inputted into a workflow 314 according to an embodiment.

A user is able to access three categories of workflows, a Site Information workflow 312, the Acceptance Testing (“ATP”) Information workflow 314, and the Third-Party Information (e.g., MIC) workflow 316.

GUI 300 includes a Radio Interface (“RIU”) Installation Planned Date 302 parameter and corresponding fillable data field refers to the date the base station or other network equipment is initially planned to be constructed/installed. In some embodiments, a user is able to select the date from a drop down menu. In some embodiments, a user is able to manually input the date.

GUI 300 includes a RIU Installation Actual Date 304 parameter and corresponding fillable data field refers to the actual date the base station or network equipment is installed. In some embodiments, a user is able to select the date from a drop down menu. In some embodiments, a user is able to manually input the date.

GUI 300 includes a Request Date For License Application 306 parameter and corresponding fillable data field refers to the date a license application is requested for review by a third-party. In some embodiments, a user is able to select the date from a drop down menu. In some embodiments, a user is able to manually input the date.

GUI 300 includes an Azimuth 308 parameter and corresponding fillable data field refers to an angular measure or a horizontal angle relative to a cardinal direction, or the direction in which the antenna on a base station or other network equipment is oriented so as to radiate or transmit a signal. In some embodiments, a user is able to manually input the azimuth.

GUI 300 includes a Serial Number Sec1 310 parameter and corresponding fillable data field refers to a serial number of a base station or other network equipment constructed or installed at a target site, and in response to a plurality of base station or other network equipment constructed or installed at a target site then a plurality of serial numbers is able to be inputted.

GUI 300 includes a Site Information 312 workflow, in which general site information 114 is viewable.

GUI 300 includes an Acceptance Testing Information 314 workflow, in which general site information 214, GSS data 104, TSS data 106, material verification data 108 is viewable.

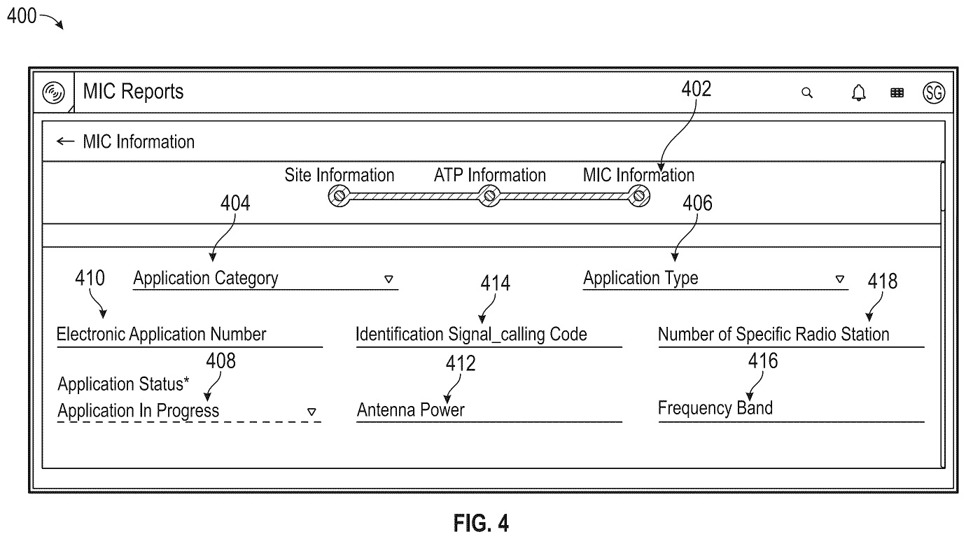

FIG. 4 is a GUI 400 of a workflow particular to information specific to the third-party, having parameters and corresponding fillable data fields and drop down menus.

GUI 400 includes Third-Party Information (e.g., MIC Information) section 402, in which additional parameters and fillable data fields necessary for obtaining a license from a particular third-party, for example MIC according to one embodiment is viewable.

GUI 400 includes Application Category 404, from which a category of application is able to be selected. In some instances, a third-party may have different categories of applications that a carrier or network provider would obtain, and a user is able to select the category from a drop down menu.

GUI 400 includes Application Type 406, from which a type of application is able to be selected. In some instances, a third-party may have different types of applications that a carrier or network provider would obtain, and a user is able to select the type from a drop down menu.

GUI 400 includes Application Status 408, which informs a user of a stage of the application able to be inputted by a user into the fillable data field, such as “Application In Progress” able to be inputted by a user into the fillable data field, indicating the application has not been completed. In some embodiments, a user is able to select a stage of the application from a drop down menu. In some embodiments, a user is able to manually input a stage of the application into a fillable data field.

GUI 400 includes Electronic Application Number 410, which refers to an identifier for the license application exported to or submitted to the third-party electronically, and able to be inputted by a user into the fillable data field. A user is able to monitor the progress of a license application by referring to this number. For example, if a third-party rejects a license application, and sends a feedback report to the report manager, the report manager is able to inform the responsible manager that a particular license application needs to be corrected, and the report manager and the responsible manager would both be able to refer to the particular license application by electronic application number 410 in the license application module.

GUI 400 includes Antenna Power 412, which refers to the output of a base station or other network equipment, and stations with more power output are able to provide greater coverage in an area, and are less impacted by interference able to disrupt a signal, and able to be inputted by a user into the fillable data field.

GUI 400 includes Identification Signal 414, which refers to a unique identifier signal linked to a particular base station or other network equipment, and able to be inputted by a user into the fillable data field.

GUI 400 includes Frequency Band 416, which refers to the frequency strength of the signal for a base station or other network equipment, the frequency measured in hertz (Hz), and able to be inputted by a user into the fillable data field. In some embodiments, a user is able to input a frequency range as base stations or other network equipment are able to be tuned to other frequencies that fall within the range to avoid potential problems created by interference and frequencies cancelling each other out.

GUI 400 includes a Number of Specific Radio Station(s) 418, which refers to an identifier of a radio station or other network equipment, able to be inputted by a user into the fillable data field.

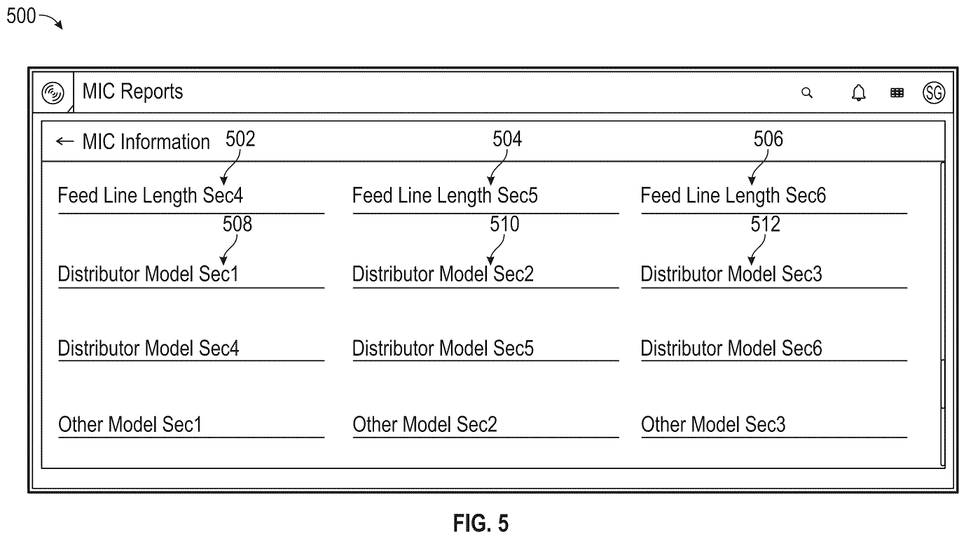

In FIG. 5 is a GUI 500 of parameters corresponding to fillable data fields to receive information inputted by a user. There are a plurality of parameters and fillable data fields for each sector, for example, Sector 1, Sector 2, and Sector 3 each have a Distributor Model parameter and corresponding fillable data field.

GUI 500 includes Feed Line Lengths 502, 504, and 506 parameters, which refer to a wire that transports the transmitted signal from the transceiver to the antenna, in Sector 4, Sector 5, and Sector 6, respectively, and able to be inputted by a user into the fillable data field.

GUI 500 includes a Distributor Models 508, 510, and 512 parameters corresponding to Sector 1, Sector 2, and Sector 3, respectively.

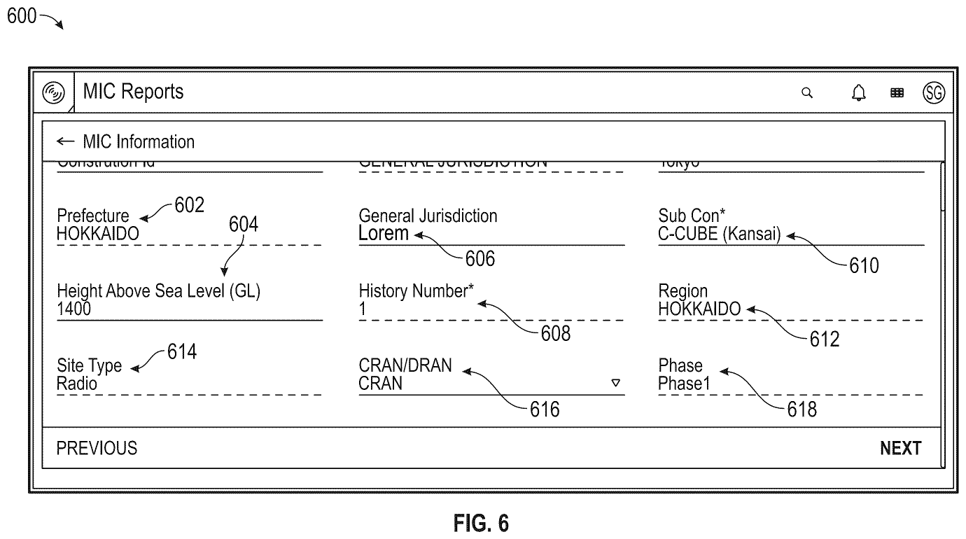

FIG. 6 is a GUI 600 having parameters and corresponding fillable data fields where location information is able to be entered according to an embodiment.

GUI 600 includes a Prefecture 602 parameter and corresponding fillable data field, which refer to a geographic locality, for example Hokkaido in Japan as shown in the data field, where a base station or other equipment is constructed or installed, and able to be inputted by a user into the fillable data field.

GUI 600 includes a Height Above Sea Level 604 parameter and corresponding fillable data field, which refer to the height above sea level at which a base station or other equipment is constructed or installed, for example 1400′ above sea level as shown in the data field, and able to be inputted by a user into the fillable data field.

GUI 600 includes a General Jurisdiction 606 parameter and corresponding fillable data field, which refer to the local municipality in which a base station or other equipment is constructed or installed, and able to be inputted by a user into the fillable data field.

GUI 600 includes a History Number 608 parameter and corresponding fillable data field, which refer to the number of times a request for a license application has been submitted to a third-party, for example one instance as shown in the data field, able to be inputted by a user into the fillable data field.

GUI 600 includes a Sub Con 610 parameter and corresponding fillable data field, which refer to the sub-contractor or the construction partner constructing or installing the base station or other equipment, for example C-CUBE (Kansai), and able to be inputted by a user into the fillable data field.

GUI 600 includes a Region 612 parameter and corresponding fillable data field, which refer to the regional locality in which a base station or other equipment is constructed or installed, and able to be inputted by a user into the fillable data field.

GUI 600 includes a Site Type 614 parameter and corresponding fillable data field, which refers to the type of equipment constructed or installed on a site, for example a radio base station, and able to be inputted by a user into the fillable data field.

GUI 600 includes a CRAN/DRAN 616 parameter and corresponding fillable data field, which refers to a central-radio access network or a de-centralized radio access network. In a CRAN, most of the signal processing is done at a hub for multiple base stations or other types of antenna sites. In a DRAN, all of the signal processing is done locally at each base station or antenna site, and able to be inputted by a user into the fillable data field.

GUI 600 includes a Phase 618 parameter and corresponding data fillable field, which refers to the stage leading up to approval or rejection of the license application. In this example, the Phase is Phase 1 and the third-party reviewing the license application is able to determine, for example, that the sub-contractor 610, C-Cube constructed or installed a radio base station on the site 614, and able to be inputted by a user into the fillable data field.

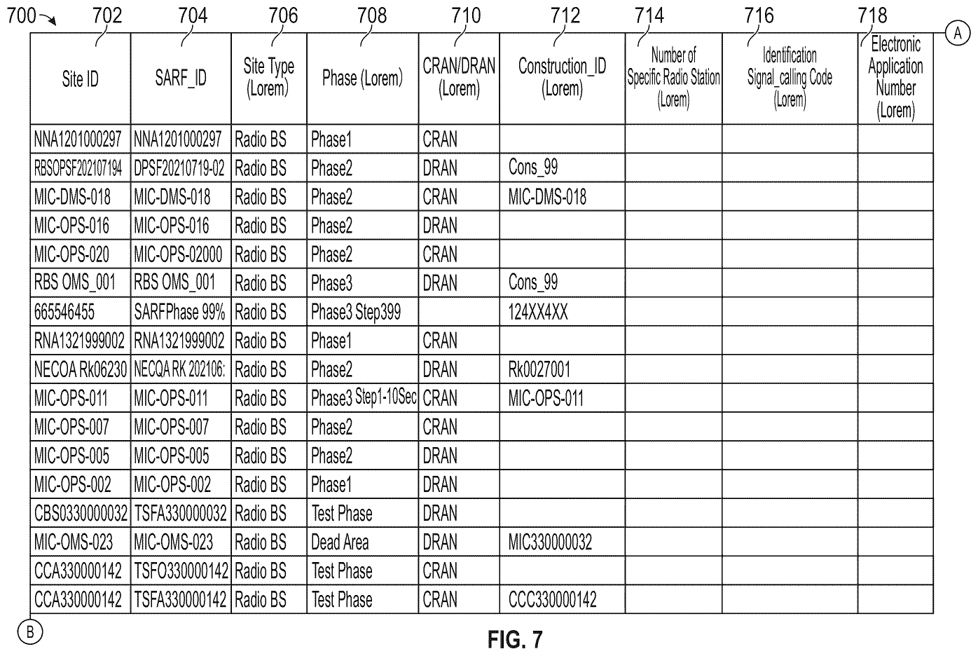

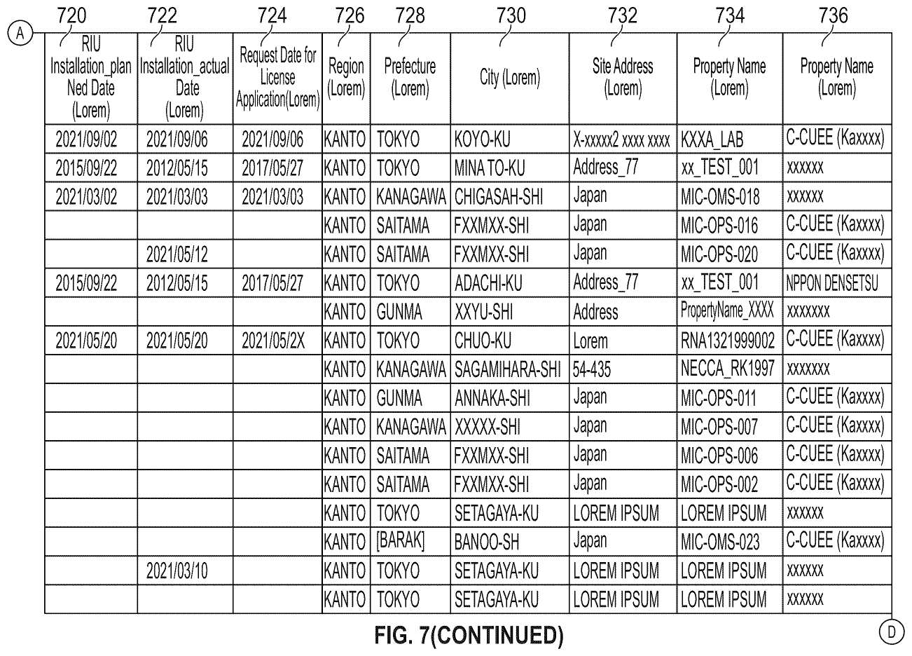

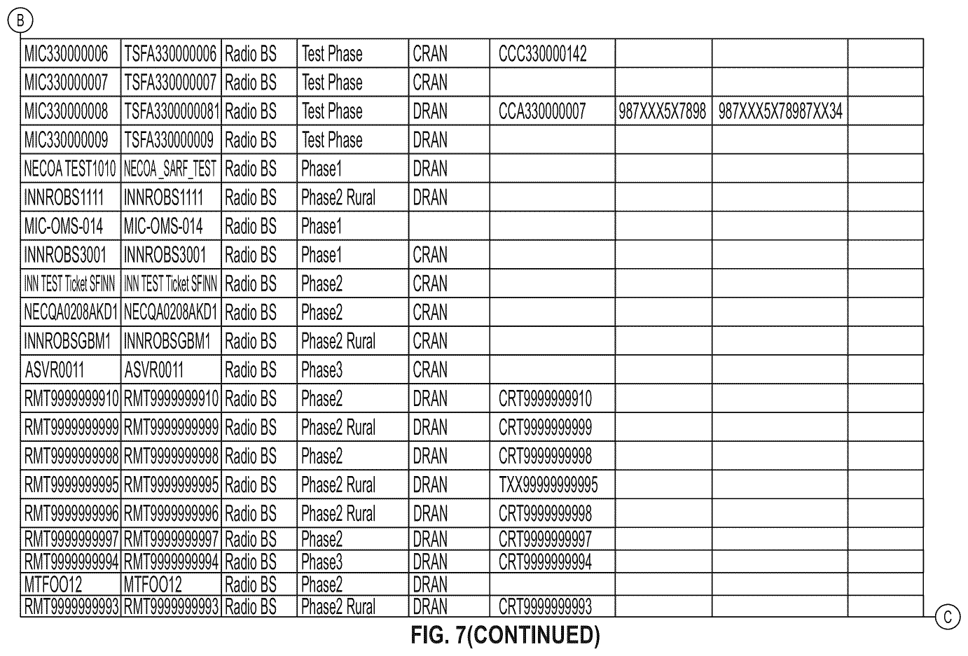

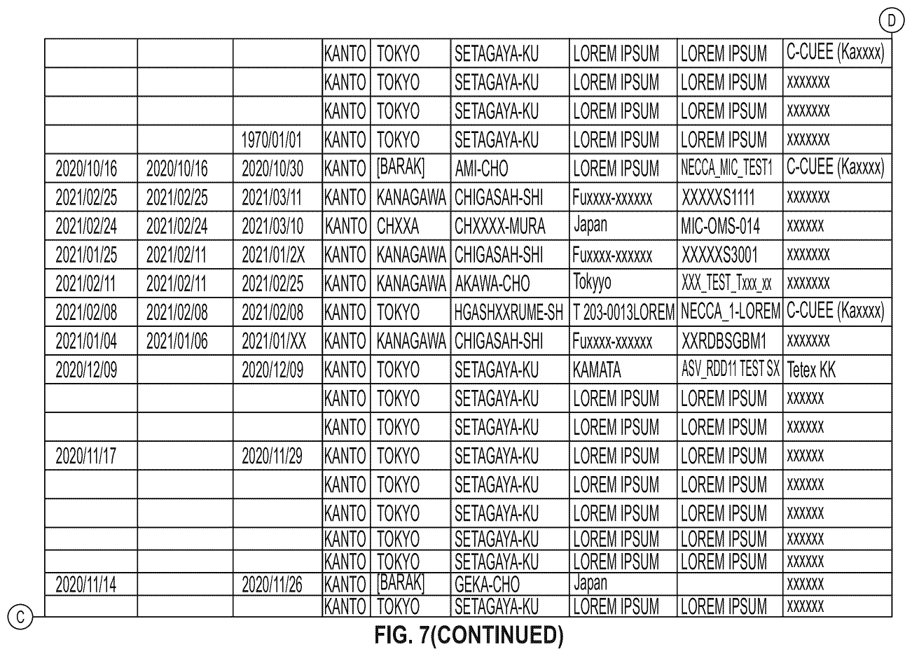

FIG. 7 is a GUI 700 of a license application file which is exported to the third-party according to an embodiment. In some embodiments, the license application file is an Extensible Markup Language (“XML”) file generated by extracting the data inputted into the three section GUIs discussed above. In some embodiments, the license application file is a Comma Separated Value (“CSV”) file acceptable by a third-party granting a license. In some embodiments, the license application is generated in a different file format to meet specifications of a third-party. The features numbered in these columns have been discussed above.

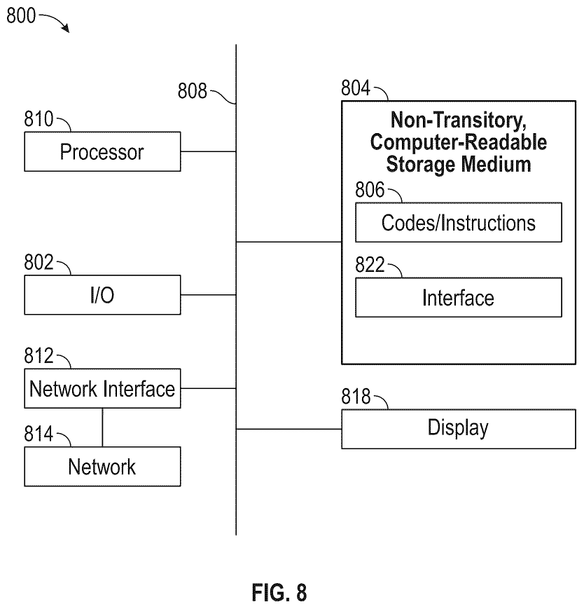

FIG. 8 is a high-level functional block diagram 800 of a processor-based system 1000 according to at least one embodiment.

In at least one embodiment, processing circuitry 800 presents a workflow module for systematically getting new base stations and network equipment online to provide more coverage for subscribers of a carrier or network provider. Processing circuitry 800 implements the workflow for systematically getting new base stations and network equipment online using processor 802. Processing circuitry 800 also includes a non-transitory, computer-readable storage medium 804 that is used to implement the workflow module. Storage medium 804, amongst other things, is encoded with, i.e., stores, instructions 806, i.e., computer program code that are executed by processor 802 causes processor 802 to perform operations for implementing the workflow module and activating a base station or other network equipment upon approving of a license application by the third-party. Execution of instructions 806 by processor 802 represents (at least in part) a visualization application for adding a adding a workflow module, wherein the visualization application implements at least a portion of the methods described herein in accordance with one or more embodiments (hereinafter, the noted processes and/or methods).

Processor 802 is electrically coupled to computer-readable storage medium 804 via a bus 808. Processor 802 is electrically coupled to an Input/output (I/O) interface 810 by bus 808. A network interface 812 is also electrically connected to processor 802 via bus 1008. Network interface 812 is connected to a network 814, so that processor 802 and computer-readable storage medium 804 connect to external elements via network 814. Processor 802 is configured to execute instructions 806 encoded in computer-readable storage medium 804 to cause processing circuitry 800 to be usable for performing at least a portion of the processes and/or methods. In one or more embodiments, processor 802 is a Central Processing Unit (CPU), a multi-processor, a distributed processing system, an Application Specific Integrated Circuit (ASIC), and/or a suitable processing unit.

Processing circuitry 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

Processing circuitry 800 also includes network interface 812 coupled to processor 802. Network interface 812 allows processing circuitry 800 to communicate with network 814, to which one or more other computer systems are connected. Network interface 812 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or IEEE-864 (Institute of Electrical and Electronics Engineers-864).

Processing circuitry 800 is configured to receive information through I/O interface 1010. The information received through I/O interface 810 includes one or more of instructions, data, design rules, libraries of cells, and/or other parameters for processing by processor 802. The information is transferred to processor 802 via bus 808. Processing circuitry 800 is configured to receive information, such as configuration input, via a User Interface (UI) through I/O interface 1010. The information is stored in computer-readable medium 804 as UI 822.

In one or more embodiments, one or more non-transitory computer-readable storage media 1004 having stored thereon instructions (in compressed or uncompressed form) that may be used to program a computer, processor, or other electronic device to perform processes or methods described herein. The one or more non-transitory computer-readable storage media 1004 include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 1004 includes a Compact Disk-Read Only Memory (CD-ROM), a Compact Disk-Read/Write (CD-R/W), and/or a Digital Video Disc (DVD).

Separate instances of these programs can be executed on or distributed across any number of separate computer systems. Thus, although certain steps have been described as being performed by certain devices, software programs, processes, or entities, this need not be the case. A variety of alternative implementations would likely be understood by one having ordinary skill in the art.

An aspect of the description relates to a method of automating and monitoring a license application in a license application module for a telecommunication network, the method comprising triggering, in response to completion of construction of a base station in the telecommunication network, generation of the license application in the license application module; reviewing of the license application in the license application module to determine compliance with a criteria of a third-party; exporting of the license application from a database in the license application module in a format compatible to be received at an external database by the third-party; and receiving, by the carrier, a response from the third-party, wherein the response indicates whether the license application to activate a base station or other network equipment is approved.

The method of automating and monitoring the license application in the license application module for the telecommunication network according to claim 1, further comprising surveying of a general site and a technical site of the base station to obtain general site data and technical site data, respectively.

The method of automating and monitoring the license application in the license application module for the telecommunication network according to claim 2, further comprising receiving of the general site data and the technical site data in a plurality of fillable data fields from the database.

The method of automating and monitoring the license application in the license application module for the telecommunication network according to claim 2, wherein the surveying is based on parameters comprising a latitude, longitude, antenna type, azimuth, height above sea level, ground height, feed line model, feed line length, distributor model, and certification number, of the base station.

The method of automating and monitoring the license application in the license application module for the telecommunication network according to claim 1, further comprising triggering, in response to a rejection of the license application by the third-party, a communication to the carrier describing a cause of the rejection.

The method of automating and monitoring the license application in the license application module for the telecommunication network according to claim 1, wherein the reviewing further comprises successive levels of verification of the license application, and in response to a first level of verification of the successive levels of verification and the first level of verification is without error, a second level of verification is triggered in response to the first level of verification being without error.

The method of automating and monitoring the license application in the license application module for the telecommunication network according to claim 1, wherein the criteria is based on technical regulations governing radio equipment.

The method of automating and monitoring the license application in the license application module for the telecommunication network according to claim 1, wherein the exporting of the license application is in an XML format.

An aspect of the description relates to a computer device for automating and monitoring the license application in a license application module for a telecommunication network, the computer device comprising: a non-transitory computer readable medium configured to store computer executable instructions; at least one processor, wherein in response to executing the computer executable instructions, the processor is configured to: trigger, in response to completion of construction of a base station in the telecommunication network, generation of a license application in the license application module; review of the license application in the license application module to determine compliance with a criteria of a third-party; export of the license application from a database in the license application module in a format compatible to be received at an external database by the third-party; and receive, by the carrier, a response from the third-party, wherein the response indicates whether the license application to activate a base station or other network equipment is approved.

The computer device for automating and monitoring the license application in the license application module for the telecommunication network according to claim 9, further comprising a survey of a general site and a technical site of the base station to obtain general site data and technical site data, respectively.

The computer device for automating and monitoring the license application in the license application module for the telecommunication network according to claim 10, wherein a plurality of fillable data fields from the database are configured to receive the general site data and the technical site data.

The computer device for automating and monitoring the license application in the license application module for the telecommunication network according to claim 10, wherein the survey is based on parameters comprising a latitude, longitude, antenna type, azimuth, height above sea level, ground height, feed line model, feed line length, distributor model, and certification number, of the base station.

The computer device for automating and monitoring the license application in the license application module for the telecommunication network according to claim 9, further comprising a communication to the carrier describing, in response to a rejection of the license application by the third-party, a cause of the rejection.

The computer device for automating and monitoring the license application in the license application module for the telecommunication network according to claim 9, wherein the review further comprises successive levels of verification of the license application, and in response to a first level of verification of the successive levels of verification and the first level of verification is without error, a second level of verification is triggered in response to the first level of verification being without error.

An aspect of the description relates to a non-transitory computer readable medium configured to store computer executable instructions, wherein in response to executing the computer executable instructions, a processor is configured to: generate a license application in a license application module in response to a notification of completion of construction of a base station in a telecommunication network; determine compliance of a license application in the license application module with a criteria of a third-party; export the license application from a database in the non-transitory computer readable medium in a format compatible to be received at an external database by the third-party; and receive a response from the third-party, wherein the response indicates whether the license application from the third-party in the license application module of the carrier to activate a base station or other network equipment is approved.

The non-transitory computer readable medium according to claim 15, wherein the processor is further configured to obtain general site data and technical site data based on a survey of a general site and a technical site of the base station.

The non-transitory computer readable medium according to claim 16, wherein the processor is further configured to receive the general site data and the technical site data from the database in a plurality of corresponding fillable data fields.

The non-transitory computer readable medium according to claim 16, wherein the survey is based on parameters comprising a latitude, longitude, antenna type, azimuth, height above sea level, ground height, feed line model, feed line length, distributor model, and certification number, of the base station.

The non-transitory computer readable medium according to claim 15, wherein the processor is further configured to receive a communication from the third-party to the carrier describing, in response to a rejection of the license application by the third-party, a cause of the rejection.

The non-transitory computer readable medium according to claim 15, wherein the determination of compliance further comprises successive levels of verification of the license application, and in response to a first level of verification of the successive levels of verification and the first level of verification is without error, a second level of verification is triggered in response to the first level of verification being without error.

What is claimed is:

1. A method of automating and monitoring a license application in a license application module for a telecommunication network, the method comprising:
triggering, in response to completion of construction of a base station in the telecommunication network, generation of the license application in the license application module;
reviewing of the license application in the license application module to determine compliance with a criterion of a third-party;
exporting of the license application from a database in the license application module in a format compatible to be received at an external database by the third-party; and
receiving, by the carrier, a response from the third-party, wherein the response indicates whether the license application to activate a base station or other network equipment is approved.

2. The method of automating and monitoring the license application in the license application module for the telecommunication network according to claim 1, further comprising surveying of a general site and a technical site of the base station to obtain general site data and technical site data, respectively.

3. The method of automating and monitoring the license application in the license application module for the telecommunication network according to claim 2, further comprising receiving of the general site data and the technical site data in a plurality of fillable data fields from the database.

4. The method of automating and monitoring the license application in the license application module for the telecommunication network according to claim 2, wherein the surveying is based on parameters comprising a latitude, longitude, antenna type, azimuth, height above sea level, ground height, feed line model, feed line length, distributor model, and certification number, of the base station.

5. The method of automating and monitoring the license application in the license application module for the telecommunication network according to claim 1, further comprising triggering, in response to a rejection of the license application by the third-party, a communication to the carrier describing a cause of the rejection.

6. The method of automating and monitoring the license application in the license application module for the telecommunication network according to claim 1, wherein the reviewing further comprises successive levels of verification of the license application, and in response to a first level of verification of the successive levels of verification and the first level of verification is without error, a second level of verification is triggered in response to the first level of verification being without error.

7. The method of automating and monitoring the license application in the license application module for the telecommunication network according to claim 1, wherein the criteria is based on technical regulations governing radio equipment.

8. The method of automating and monitoring the license application in the license application module for the telecommunication network according to claim 1, wherein the exporting of the license application is in an XML format.

9. A computer device for automating and monitoring the license application in a license application module for a telecommunication network, the computer device comprising:
a non-transitory computer readable medium configured to store computer executable instructions;
at least one processor, wherein in response to executing the computer executable instructions, the processor is configured to:
trigger, in response to completion of construction of a base station in the telecommunication network, generation of a license application in the license application module;
review of the license application in the license application module to determine compliance with a criterion of a third-party;
export of the license application from a database in the license application module in a format compatible to be received at an external database by the third-party;
receive, by the carrier, a response from the third-party, wherein the response indicates whether the license application to activate a base station or other network equipment is approved.

10. The computer device for automating and monitoring the license application in the license application module for the telecommunication network according to claim 9, further comprising a survey of a general site and a technical site of the base station to obtain general site data and technical site data, respectively.

11. The computer device for automating and monitoring the license application in the license application module for the telecommunication network according to claim 10, wherein a plurality of fillable data fields from the database are configured to receive the general site data and the technical site data.

12. The computer device for automating and monitoring the license application in the license application module for the telecommunication network according to claim 10, wherein the survey is based on parameters comprising a latitude, longitude, antenna type, azimuth, height above sea level, ground height, feed line model, feed line length, distributor model, and certification number, of the base station.

13. The computer device for automating and monitoring the license application in the license application module for the telecommunication network according to claim 9, further comprising a communication to the carrier describing, in response to a rejection of the license application by the third-party, a cause of the rejection.

14. The computer device for automating and monitoring the license application in the license application module for the telecommunication network according to claim 9, wherein the review further comprises successive levels of verification of the license application, and in response to a first level of verification of the successive levels of verification and the first level of verification is without error, a second level of verification is triggered in response to the first level of verification being without error.

15. A non-transitory computer readable medium configured to store computer executable instructions, wherein in response to executing the computer executable instructions, a processor is configured to:
generate a license application in a license application module in response to a notification of completion of construction of a base station in a telecommunication network;
determine compliance of a license application in the license application module with a criterion of a third-party;
export the license application from a database in the non-transitory computer readable medium in a format compatible to be received at an external database by the third-party;
receive a response from the third-party, wherein the response indicates whether the license application from the third-party in the license application module of the carrier to activate a base station or other network equipment is approved.

16. The non-transitory computer readable medium according to claim 15, wherein the processor is further configured to obtain general site data and technical site data based on a survey of a general site and a technical site of the base station.

17. The non-transitory computer readable medium according to claim 16, wherein the processor is further configured to receive the general site data and the technical site data from the database in a plurality of corresponding fillable data fields.

18. The non-transitory computer readable medium according to claim 16, wherein the survey is based on parameters comprising a latitude, longitude, antenna type, azimuth, height above sea level, ground height, feed line model, feed line length, distributor model, and certification number, of the base station.

19. The non-transitory computer readable medium according to claim 15, wherein the processor is further configured to receive a communication from the third-party to the carrier describing, in response to a rejection of the license application by the third-party, a cause of the rejection.

20. The non-transitory computer readable medium according to claim 15, wherein the determination of compliance further comprises successive levels of verification of the license application, and in response to a first level of verification of the successive levels of verification and the first level of verification is without error, a second level of verification is triggered in response to the first level of verification being without error.
